(19) United States
(12) Patent Application Publication
(10) Pub. No.: US 2014/0227969 A1
(43) Pub. Date: Aug. 14, 2014

(54) INDIUM TIN OXIDE LOOP ANTENNA FOR NEAR FIELD COMMUNICATION

(71) Applicant: LSI CORPORATION, San Jose, CA (US)

(72) Inventor: Roger A. Fratti, Mohnton, PA (US)

(73) Assignee: LSI Corporation, San Jose, CA (US)

(21) Appl. No.: 13/785,186

(22) Filed: Mar. 5, 2013

Related U.S. Application Data
(60) Provisional application No. 61/763,183, filed on Feb. 11, 2013.

(51) Int. Cl. H04B 1/38; B05D 5/12

(52) U.S. Cl. CPC H04B 1/3827; B05D 5/12
USPC 455/41.1; 455/73; 455/90.2; 427/58; 29/600

(57) ABSTRACT

An apparatus includes a display and a transceiver. The display has a lateral surface. The lateral surface has disposed thereon a line comprising a thin-film conductive material. The line is patterned to form one or more loops around the display. The transceiver is electrically connected to the line. The line forms a radiating structure during a radio frequency (RF) operation.

### FIELD OF THE INVENTION

The invention relates to mobile communication generally and, more particularly, to a method and/or apparatus for implementing an indium tin oxide loop antenna for near field communication.

### BACKGROUND

Conventional mobile devices can include an antenna for near field communication (NFC) such as USB links. A conventional NFC antenna consists of a coil of copper wire or a flat conductive coil trace pattern formed on either a top or bottom surface of a substrate. Care must be taken in the placement of the NFC antenna on the top or bottom surfaces to avoid interference with displays and other structures such as touchscreen conductors. In some conventional devices, the NFC antenna is located on a separate printed circuit board (PCB) substrate. The addition of a separate printed circuit board substrate increases manufacturing and bill of material (BOM) costs, as well as increases the weight of the mobile device.

It would be desirable to have an indium tin oxide loop antenna for near field communication that reduces placement and BOM cost considerations.

### SUMMARY

The invention concerns an apparatus including a display and a transceiver. The display has a lateral surface. The lateral surface has disposed thereon a line comprising a thin-film conductive material. The line is patterned to form one or more loops around the display. The transceiver is electrically connected to the line. The line forms a radiating structure during a radio frequency (RF) operation.

### BRIEF DESCRIPTION OF THE FIGURES

Embodiments of the invention will be apparent from the following detailed description and the appended claims and drawings in which:

FIG. 1 is a diagram illustrating an indium tin oxide (ITO) loop antenna in accordance with an embodiment of the invention;

FIG. 2 is a diagram illustrating a variation of the indium tin oxide (ITO) loop antenna of FIG.

FIG. 3 is a diagram illustrating another variation of the indium tin oxide (ITO) loop antenna of FIG. 1;

FIG. 4 is a diagram illustrating an indium tin oxide (ITO) loop antenna in accordance with another embodiment of the invention; and

FIG. 5 is a diagram illustrating a game controller in which an indium tin oxide (ITO) loop antenna in accordance with an embodiment of the invention may be implemented.

### DETAILED DESCRIPTION OF THE PREFERRED EMBODIMENTS

Embodiments of the invention include providing a thin-film (e.g., indium tin oxide (ITO), etc.) loop antenna for near field communication (NFC) that may (i) reduce a bill of materials (BOM) for a radio frequency device, (ii) reduce cost, (iii) reduce weight, and/or (iv) locate a near field communication loop antenna on a lateral surface of a liquid crystal display (LCD).

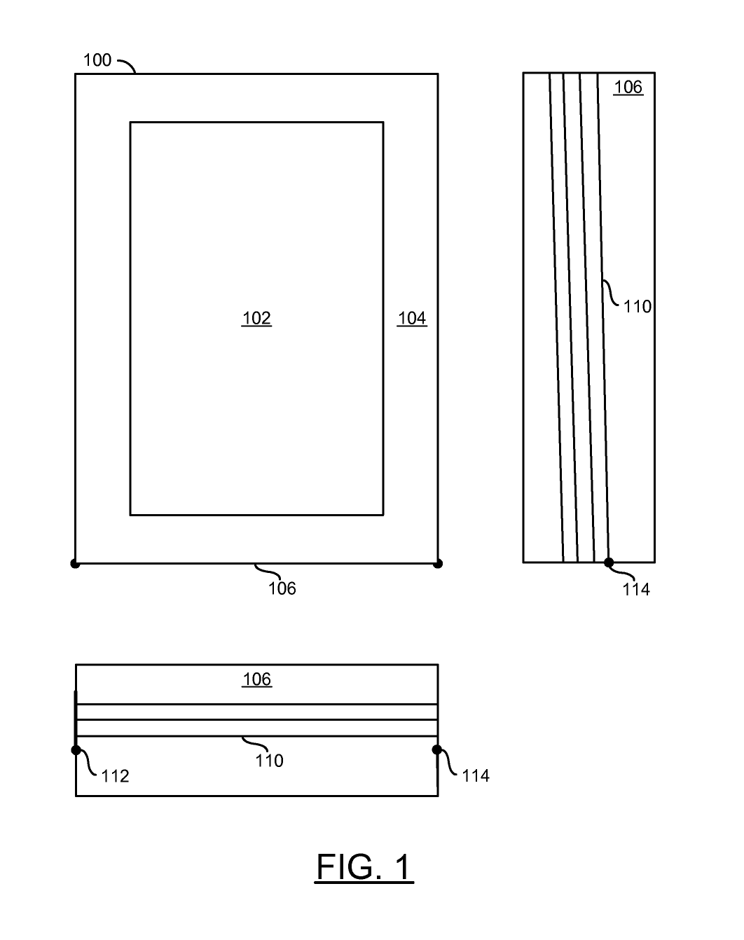

Referring to FIG. 1, a diagram is shown illustrating a display 100 in accordance with an embodiment of the invention. In some embodiments, the display 100 may implement a liquid crystal display (LCD). In other embodiments, the display 100 may combine an LCD display and a touchscreen. The display 100 generally has a central visible portion 102 through which images are displayed. The display 100 may also have a peripheral region 104 surrounding the visible portion 102. The peripheral region 104 is generally not used for images and may be hidden (e.g., by a bezel) within a housing in which the display 100 is mounted.

The top surface of the display 100 may comprise a flexible optical grade plastic (e.g., polyethylene terephthalate (PET), polyester, etc.) or a stable substantially rigid transparent material (e.g., glass, acrylic, etc.). The display 100 generally includes a lower layer or layers implementing the display (e.g., LCD, LED, TFT, etc.). The layers of the display 100 are generally held together and sealed with a gasket adhesive, which isolates the display and/or touchscreen from the external environment. The display 100 has a lateral surface 106. The lateral surface 106 is generally perpendicular to the top surface of the display 100 and comprises four connected regions which are generally referred to as sides of the display 100.

The sides of the display 100 may comprise plastic or glass areas on which a circuit layer comprising a thin-film conducting material (e.g., indium tin oxide (ITO), indium zinc oxide (IZO), etc.) is deposited and patterned to form a line 110 having one or more loops. The line and loop(s) 110 may be configured (e.g., length and thickness adjusted) to form a radiating (antenna) structure appropriate for RF operation (e.g., transmitting, receiving, performing near field communication, etc.). For example, the line and loop(s) 110 may be sized, in some embodiments, for operation at a frequency of about 13.6 MHz. The line and loop(s) 110 may be sized for forming a radiating structure for other (e.g., higher, lower, etc.) frequencies as well. For example, the skin effect at 2.5 and 5.2 GHz keeps most of the electrons in the outer surface of the thin-film conducting material, so the fact that the line and loop(s) 110 comprise a thin wire is generally not an issue. Although the radiation resistance and dissipation resistance may be higher than for a very thick copper line, the higher radiation resistance and dissipation resistance may be compensated for with a transceiver matching circuit. In comparison, conventional antennas are typically electrically small and have less than desirable directivity (e.g., 1.2 to 1.8 dBi). In addition, because the line and loop(s) 110 are located outside the visible (viewing) region 102 of the display 100, a thicker layer of the thin-film conducting material may be used to reduce the resistance.

The thin-film conducting material may be deposited (e.g., sputtered, etc.) on the lateral surface 106 of the display 100. The thin-film conducting material may be patterned (e.g., etched) to form the line and loop(s) 110, as well as connecting pads 112 and 114. In one example, an insulating layer may be deposited to allow connection of the pad 112 to an upper end of the line and loop(s) 110.

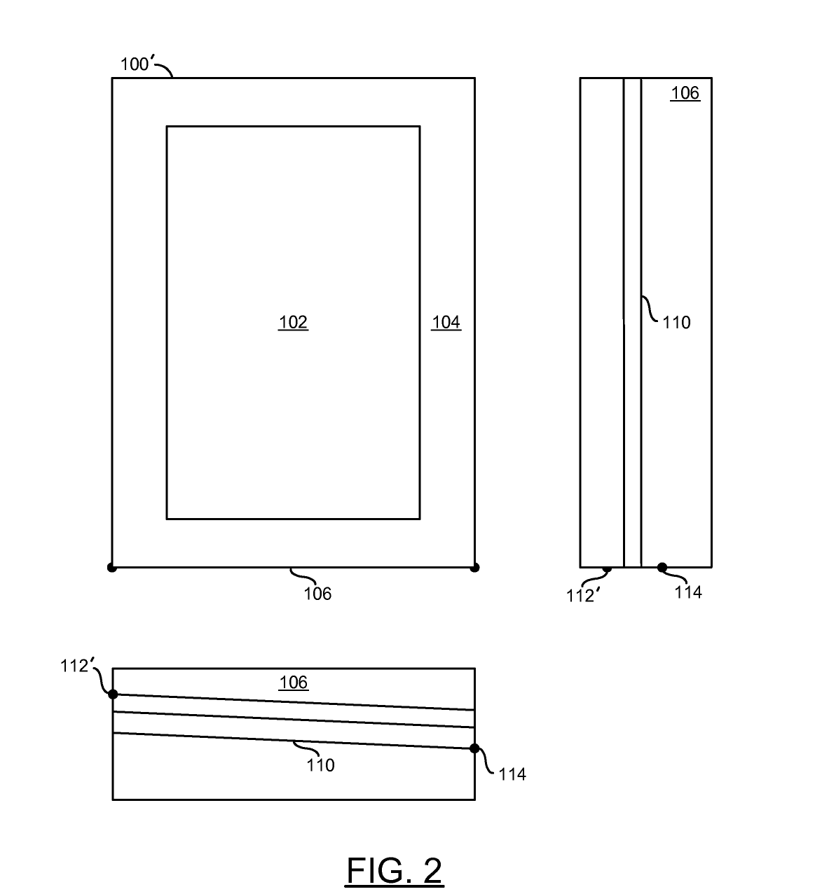

Referring to FIG. 2, a diagram of a display 100′ is shown illustrating a variation of the indium tin oxide (ITO) loop(s) 110 of FIG. 1. In some embodiments, the contact 112 may be replaced by a contact 112′ located at an upper corner of the loop structure. By locating the contact 112′ at the upper corner, an insulating layer is no longer need to separate the connection to the contact 112′ from the loop(s) 110.

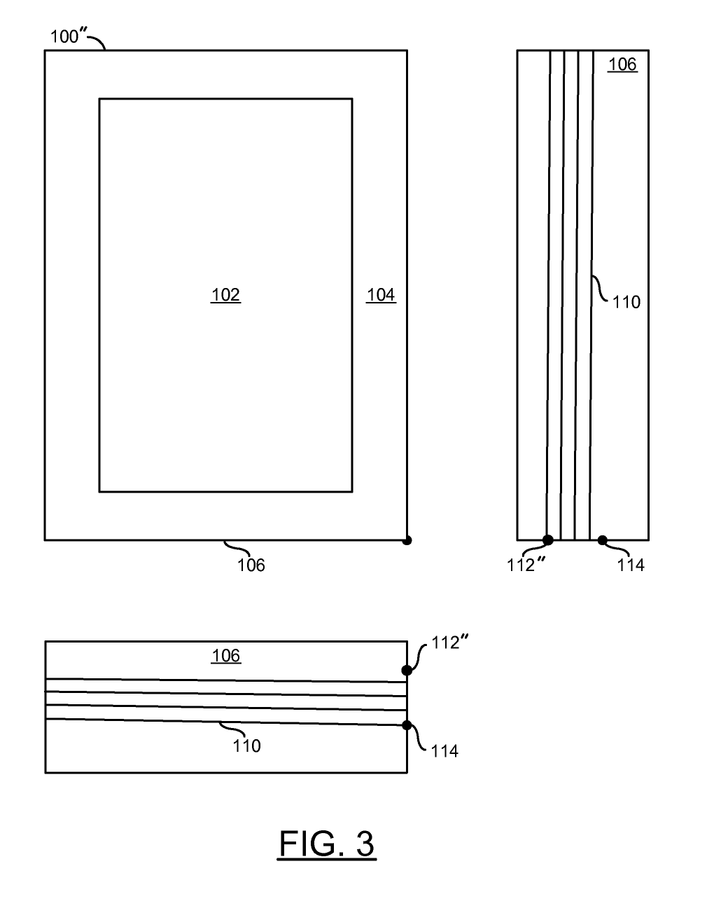

Referring to FIG. 3, a diagram of a display 100″ is shown illustrating another variation of the indium tin oxide (ITO) loop(s) 110 of FIG. 1. In some embodiments, the contact 112′ may be replaced by a contact 112″ located directly above the contact 114. Although the contacts 112, 112′, 112″, and 114 have been shown at corners of the displays 100, 100′, and 100″, It will be apparent to those skilled in the field of the invention that the contacts could also be located on the lateral surface regions (sides) of the displays.

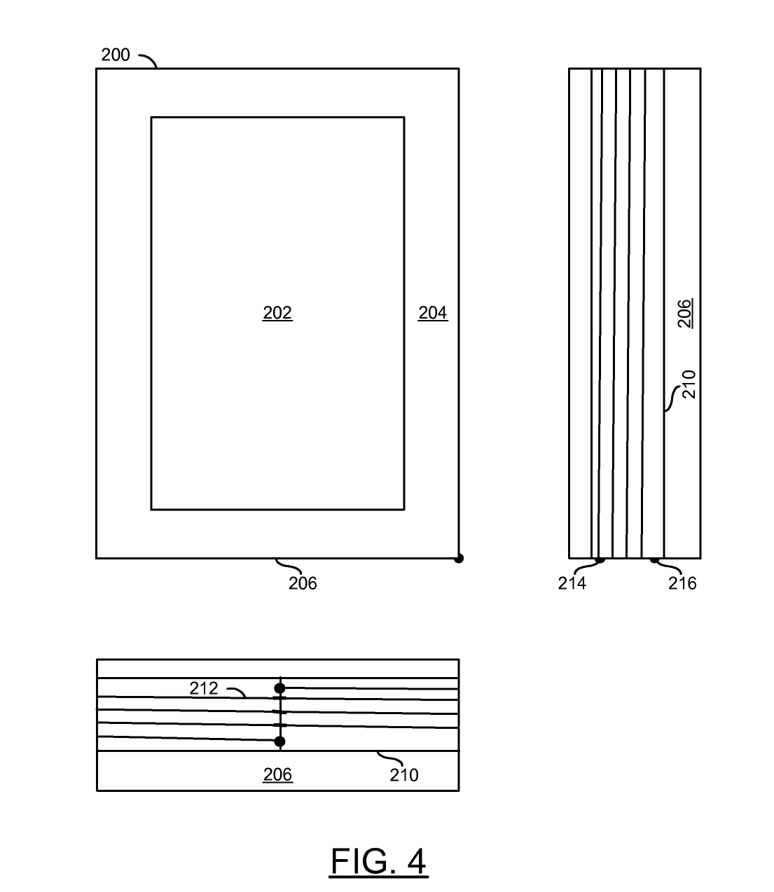

Referring to FIG. 4, a diagram is shown illustrating a display 200 in accordance with another embodiment of the invention. Similar to the display 100 of FIG. 1, the display 200 may implement a liquid crystal display (LCD) or other type of display. In some embodiments, the display 200 may combine the display with a touchscreen. The display 200 generally has a central visible portion 202 through which images are displayed. The display 200 may also have a peripheral region 204 surrounding the visible portion 202. The peripheral region 204 is generally not used for images and may be hidden (e.g., by a bezel) within a housing in which the display 200 is mounted. The layers of the display 200 are generally held together and sealed with a gasket adhesive, which isolates the display and/or touchscreen from the external environment. The gasket seal generally forms a lateral surface 206 of the display 200. The lateral surface 206 is generally perpendicular to the top surface of the display 200 and comprises four connected regions which are generally referred to as sides of the display 200.

In some embodiments, a flexible strip 210 with one or more line segments 212 may be attached (e.g., bonded, glued, adhered, etc.) to the lateral surface 206 of the display 200. The line segments 212 may comprise a thin-film conducting material (e.g., ITO, IZO, etc.). The line segments 212 may be connected together at a point where ends of the strip 210 meet to form a continuous loop antenna. The loop antenna formed by the line segments 212 may be connected to RF circuitry via a contact 214 and a contact 216. In one example, the contacts 214 and 216 may be formed at the junction of the ends of the strip 210. The contact 214 may be connected to an upper end of the loop antenna and the contact 216 may be connected to a lower end of the loop antenna.

The thin-film conducting material forming the line segments 212 may be deposited (e.g., sputtered, etc.) on the flexible strip 210. The flexible strip 210 may comprise a flexible material (or substrate) such as polyethylene terephthalate (PET), polyester, etc. The thin-film conducting material may be patterned (e.g., etched) to form the line(s) 212, as well as pads for the contacts 214 and 216.

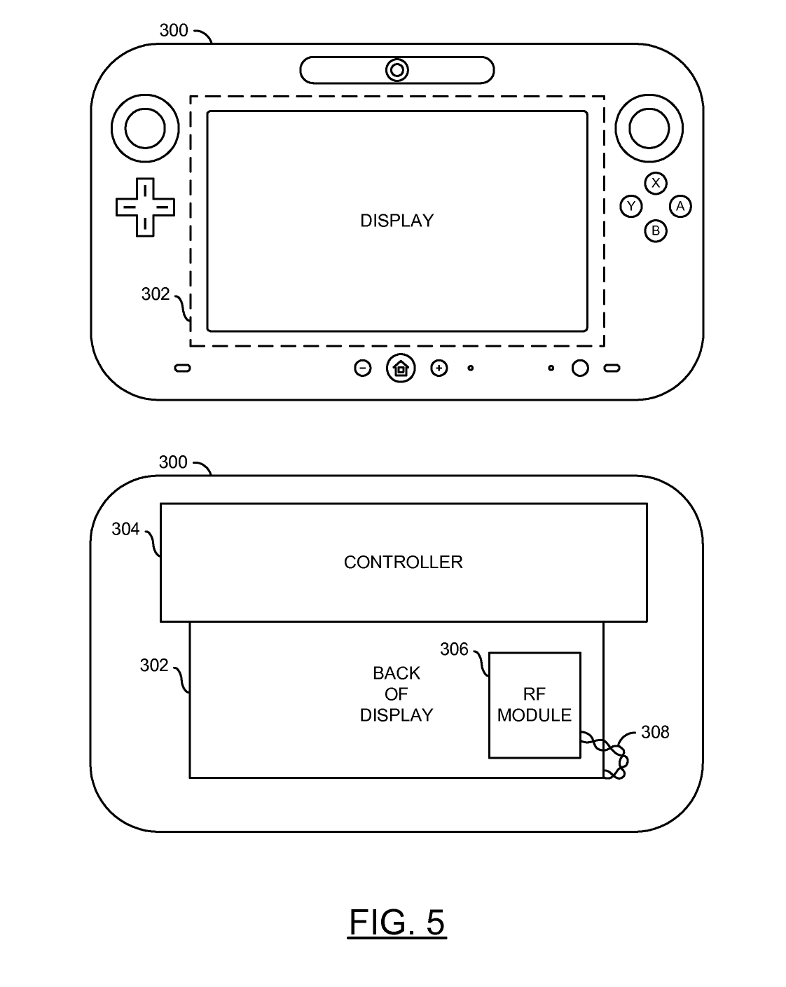

Referring to FIG. 5, a diagram is shown illustrating a device 300 in which an indium tin oxide (ITO) loop antenna in accordance with an embodiment of the invention may be implemented. The device 300 may be implemented, for example, as a game controller, a tablet computer, a personal digital assistant (PDA), smart phone, or other mobile device. The device 300 generally comprises a display 302. The display 302 generally has a central visible portion through which images are displayed and a peripheral portion which is generally not used for images and is generally hidden within a case of the device 300. The device 300 may further comprise a controller 304 and an RF module 306. The RF module may be configured for near field communication. The RF module 306 may be implemented using conventional circuitry. The RF module 306 may be connected to a loop antenna by a pair of wires 308. In some embodiments, the loop antenna and contacts for connection of the wires 308 may be implemented as described above in connection with FIGS. 1-4. The loop antenna is generally configured with an appropriate length for an operating frequency (e.g., 13.6 MHz) according to a particular near field communication protocol implemented by the device 300.

In some embodiments, a device comprising a display may be implemented with a thin-film (e.g., ITO, IZO, etc.) loop antenna disposed around a lateral surface of the display. Disposing the antenna around the lateral surface of the display avoids interference with viewing of the display, as well as interconnections that may also be located in the periphery of the top surface of the display (e.g., for supporting connection to an electro grid used as a touchscreen). In general, the ITO loop antenna may be formed as one or more loops of material traversing around the lateral surface of the display. The ITO loop may be formed with a thickness providing a low resistance and, therefore, better antenna characteristics since the lateral surface of the display is not used for transmitting an image as is the top surface. In alternative embodiments, the technique of using the lateral surface of the display as the location for the near field communication antenna may also support the placement of other types of antennae (e.g., whip, monopole, di-pole, etc.), which could be placed along less than all four sides of the display.

Although the examples described above refer to indium tin oxide (ITO) and/or indium zinc oxide (IZO), it will be apparent to those of ordinary skill in the art that the thin-film conductive (or conducting) material used to form the loop(s) 110 and lines 212 may include, for example, (i) conductive polymers (e.g., including polypyrrole, polyaniline or polythiophene), (ii) transparent conducting oxides (e.g., including tin doped indium oxide (ITO), fluorine doped zinc oxide (FZO), aluminum doped zinc oxide AlZO, indium doped zinc oxide (IZO), antimony doped tin oxide (SbTO), and fluorine doped tin oxide (FTO)), and (iii) low-resistance metallic material such as molybdenum (Mo), silver (Ag), titanium (Ti), copper (Cu), aluminum (Al), and/or molybdenum/aluminum/molybdenum (Mo/Al/Mo). The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

While the invention has been particularly shown and described with reference to embodiments thereof, it will be understood by those skilled in the art that various changes in form and details may be made without departing from the scope of the invention.

1. An apparatus comprising:
a display having a lateral surface, said lateral surface having disposed thereon a line comprising a thin-film conductive material, said line patterned to form one or more loops around said display; and
a transceiver electrically connected to the line, wherein said line forms a radiating structure during a radio frequency (RF) operation.

2. The apparatus according to claim 1, wherein said transceiver is configured to communicate according to one or more near field communication protocols.

3. The apparatus according to claim 1, wherein the thin-film conductive material comprises at least one of polypyrrole, polyaniline, polythiophene, tin doped indium oxide (ITO), fluorine doped zinc oxide (FZO), aluminum doped zinc oxide AlZO, indium doped zinc oxide (IZO), antimony doped tin oxide (SbTO), and fluorine doped tin oxide (FTO)), molybdenum (Mo), silver (Ag), titanium (Ti), copper (Cu), aluminum (Al), and molybdenum/aluminum/molybdenum (Mo/Al/Mo).

4. The apparatus according to claim 1, wherein the thin-film conductive material comprises at least one of tin doped indium oxide (ITO) and indium doped zinc oxide (IZO).

5. The apparatus according to claim 1, wherein said display further comprises a matrix resistive touchscreen.

6. The apparatus according to claim 1, wherein said apparatus is part of a portable device.

7. The apparatus according to claim 1, wherein said apparatus is part of a portable communication device.

8. The apparatus according to claim 1, wherein said apparatus is part of a game controller.

9. The apparatus according to claim 1, wherein said RF operation comprises one or more of transmitting an RF signal, receiving an RF signal, and performing near field communication.

10. The apparatus according to claim 1, wherein said line comprises a plurality of line segments disposed on a flexible strip, said flexible strip is attached to said lateral surface of said display, and said plurality of line segments are connected to form said one or more loops.

11. A method of facilitating near field communication comprising the steps of:
forming a line comprising a thin-film conductive material on a lateral surface of a display, wherein said line comprises one or more loops around said display; and
connecting a transceiver electrically to said line, wherein said line forms a radiating structure during a radio frequency (RF) operation.

12. The method according to claim 11, wherein the step of forming said line comprises:
depositing a coating of said thin-film conductive material on said lateral surface of said display;
patterning said coating of said thin-film conductive material to form said one or more loops of said line.

13. The method according to claim 12, further comprising:
patterning said coating of said thin-film conductive material to form a first contact pad at a first end of said line and a second contact pad at a second end of said line.

14. The method according to claim 13, wherein said transceiver is electrically connected to said line via said first and said second contact pads.

15. The method according to claim 11, wherein the step of forming said line comprises:
depositing a coating of said thin-film conductive material on a strip of flexible material;
patterning said coating of said thin-film conductive material to form a plurality of line segments on said strip of flexible material;
attaching said strip of flexible material to said lateral surface of said display; and
connecting said plurality of line segments to form said one or more loops.
